(19) United States
(12) Patent Application Publication
(10) Pub. No.: US 2007/0016707 A1
(43) Pub. Date: Jan. 18, 2007

(54) Configuration connector for information handling system circuit boards

(76) Inventors: John S. Loffink, Austin, TX (US); Patrick W. Carrier, Round Rock, TX (US); William F. Sauber, Georgetown, TX (US)

Correspondence Address: HAMILTON & TERRILE, LLP, P.O. BOX 203518, AUSTIN, TX, 78720, US

(21) Appl. No.: 11/180,180

(22) Filed: Jul. 13, 2005

(51) Int. Cl. G06F 13/00

(52) U.S. Cl. 710/104

(57) ABSTRACT

The present invention provides a configuration jumper that allows the main system board of an information handling system to be configured for a plurality of population options, including on-board PCI-E integrated circuits and PCI-E integrated circuits on expansion circuit boards that are connected to the main system board by an expansion slot connector. In one embodiment of the invention, the main system board comprises a first conductor and a second conductor that is selected from a plurality of second conductors that correspond to different circuit population options. The configuration jumper is operable to connect the first connector to the selected second conductor and to provide an appropriate capacitance to ensure that the signal path defined by the first conductor, the second conductor and the internal conductor of the jumper provide a combined AC coupling capacitance that complies with the AC coupling capacitor requirements of the PCI-E protocol. In alternative embodiments of the invention the four embodiments of the configuration jumpers discussed above are used to connect first pairs of differential signal conductors to second pairs of differential signal conductors. In these embodiments, the configuration jumpers comprise capacitance compensation and impedance matching to provide a capacitance-compensated, impedance-matched passthrough for high-speed differential signals used to transmit data between a PCI-E root complex and a PCI-E integrated circuit.

### BACKGROUND OF THE INVENTION

1. Field of the Invention

The present invention relates generally to circuit boards used in information handling systems. More specifically, the present invention provides an improved method and apparatus for manufacturing information system circuit boards to support multiple configurations.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In the manufacture of information handling systems, it is common to use a main system board (motherboard) that can be configured for multiple population options, including onboard integrated circuits and integrated circuits on expansion circuit boards that are connected to the main system board via an expansion slot connector.

Many of the currently available configuration options for an information handling system comprise integrated circuits that are based on the PCI Express (sometimes referred to below as “PCI-E”) protocol. PCI-E is a high-speed serial signal protocol requiring point-to-point connections. A PCI-E link is composed of one or more transmit and receive differential signal pairs. PCI-E circuit boards are required to have AC coupling capacitors between 75 and 200 nF on the transmit side of any interface for signal conductors of circuit boards connected to the main system board via an expansion slot. PCI-E integrated circuits connected directly to the main system board are not required to have the AC coupling capacitors integrated and, therefore, the system board generally will include AC coupling capacitors for both the transmit and the receive side of the link.

For a the configuration wherein the PCI-E integrated circuit is mounted on an expansion circuit board that comprises an AC coupling capacitor, only a connection jumper is needed to make the proper point-to-point connection for this configuration of the system board. In the case of the onboard PCI-E device, however, AC coupling capacitors are needed in addition to the jumper. This results in PCB real estate problems, because both jumpers and capacitors must be allocated to the layout even though they may not be used.

In addition to the design issues related to the AC coupling capacitors discussed above, configuration issues with respect to the main system board have been affected by the need to provide higher data bit rates. For example, high-speed differential signaling is increasingly used across multiple interfaces to provide an efficient means for transferring data for high-speed protocols, such as PCI-E.

Prior art techniques for routing these high speed signals through “quick switches” or zero-ohm resistors inevitably creates an impedance discontinuity, or “impedance bump” in the routing. The impedance bump creates reflections along the signal and also degrades the intrapair differential coupling ratio, thereby increasing the effects of local EMI sources on the conductor pair. As signal routing speeds for differential signals exceed three gigabits per second (Gbps), problems with impedance mismatches and associated reflections will be exacerbated.

In view of the foregoing, it is apparent that there is a need to provide a flexible configuration device that allows a main system board to be configured for a plurality of population options including onboard PCI-E integrated circuits and PCI-E expansion circuit boards that are connected to the main system board via a PCI-E compliant connector. In addition, there is a need for the circuit board configuration system to provide a means to prevent signal degradation resulting from impedance mismatching related to HSDS conductors transmitting signals at high data rates.

### SUMMARY OF THE INVENTION

The present invention overcomes the shortcomings of the prior art by providing a configuration jumper that allows the main system board of an information handling system to be configured for a plurality of population options, including on-board PCI-E integrated circuits and PCI-E integrated circuits on expansion circuit boards that are connected to the main system board by a expansion slot connector.

In one embodiment of the invention, the main system board comprises a first conductor and a second conductor that is selected from a plurality of second conductors, wherein the plurality of second conductors correspond to different circuit population options. The configuration jumper is operable to connect the first conductor to the selected second conductor and to provide an appropriate capacitance to ensure that the signal path defined by the first conductor, the second conductor and the internal conductor of the jumper provide a combined AC coupling capacitance that complies with the AC coupling capacitor requirements of the PCI-E protocol.

There are four embodiments of the configuration jumper of the present invention. In a first embodiment, the internal conductor of the jumper is operable to connect a first conductor to a second conductor that is coupled to a PCI-E integrated circuit on an expansion circuit board wherein the either the first conductor or the second conductor comprises an AC coupling capacitor. In this embodiment, the internal conductor does not comprise an AC coupling capacitor. In a second embodiment, the internal conductor of the jumper is operable to connect a first conductor to a second conductor that is coupled to a PCI-E integrated circuit on an expansion circuit board wherein neither the first conductor nor the second conductor comprises an AC coupling capacitor. In this embodiment, the internal conductor of the configuration jumper comprises an AC coupling capacitor. In a third embodiment, the configuration jumper is operable to connect a first conductor to a second conductor that is coupled to an integrated circuit on the main system board wherein either the first conductor or the second conductor comprises an AC coupling capacitor. In this embodiment, the internal conductor of the configuration jumper does not comprise an AC coupling capacitor. In a fourth embodiment, the configuration jumper is operable to connect a first conductor to a second conductor that is coupled to an integrated circuit on the main system board, wherein neither the first conductor nor the second conductor comprises an AC coupling capacitor. In this embodiment, the internal conductor of the configuration jumper comprises an AC coupling capacitor.

In alternative embodiments of the invention, the four embodiments of the configuration jumpers discussed above are used to connect first pairs of differential signal conductors to second pairs of differential signal conductors. In these embodiments, the configuration jumpers comprise capacitance compensation and impedance matching to provide a capacitance-compensated, impedance-matched passthrough for high-speed differential signals used to transmit data between a PCI-E root complex and a PCI-E integrated circuit.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system in accordance with the present invention.

FIG. 2 is a general illustration of a main system board comprising a configuration jumper in accordance with the present invention for selectively connecting a first conductor to a second conductor in accordance with the present invention.

FIG. 3 is a generalized illustration of a PCI-E topology.

FIG. 4 is an illustration of a PCI-E topology for transmitting data on first and second data paths having AC coupling capacitors.

FIGS. 5a-d are illustrations of embodiments of the capacitance-compensating configuration jumper in accordance with the present invention.

FIGS. 6-9 are illustrations of a PCI-E root complex connected to an onboard PCI-E integrated circuit or a PCI-E integrated circuit on an expansion circuit board using the embodiments of the capacitance-compensating configuration jumpers illustrated in FIGS. 5a-d.

FIG. 10 is an illustration of an implementation of an impedance-matched, capacitance-compensated configuration jumper of the present invention in a high speed differential signaling system for transmitting data from a transmitter to two possible receivers.

FIG. 11 is an illustration of an impedance-matched, capacitance-compensated configuration jumper used to connect a first differential conductor pair on a circuit board to a second differential conductor pair associated with an expansion slot connector.

FIG. 12 is an illustration of an impedance-matched, capacitance-compensated configuration jumper for connecting a first differential conductor pair on a circuit board to a second differential conductor pair associated with an onboard PCI-E circuit.

FIG. 13 is an illustration of a configuration of conductor pads for a first differential signal input conductor pair and first and second differential signal output conductor pairs.

FIG. 14a is an illustration of an impedance-matched, capacitance-compensated configuration jumper operable to connect a first differential signal input conductor pair to a first differential signal output conductor pair in accordance with the conductor configuration shown in FIG. 13.

FIG. 14b is an illustration of an impedance-matched, capacitance-compensated configuration jumper operable to connect a first differential signal input conductor pair to a second differential signal output conductor pair in accordance with the conductor configuration shown in FIG. 13.

FIG. 15 is an illustration of a configuration of conductor pads and associated ground pads for a first differential signal input conductor pair and first and second differential signal output conductor pairs.

FIG. 16a is an illustration of an impedance-matched, capacitance-compensated configuration jumper operable to connect a first differential signal input conductor pair to a first differential signal output conductor pair using the conductor configuration illustrated in FIG. 15.

FIG. 16b is an illustration of an impedance-matched, capacitance-compensated configuration jumper operable to connect a first differential signal input conductor pair to a second differential signal output conductor pair using the conductor configuration illustrated in FIG. 15.

FIG. 17 is an illustration of layout geometries for conductor pads to create 100 ohms of differential impedance.

FIG. 18 is an illustration of layout geometries of a plurality of conductors embedded in a substrate with a predetermined spacing from a groundplane.

### DETAILED DESCRIPTION

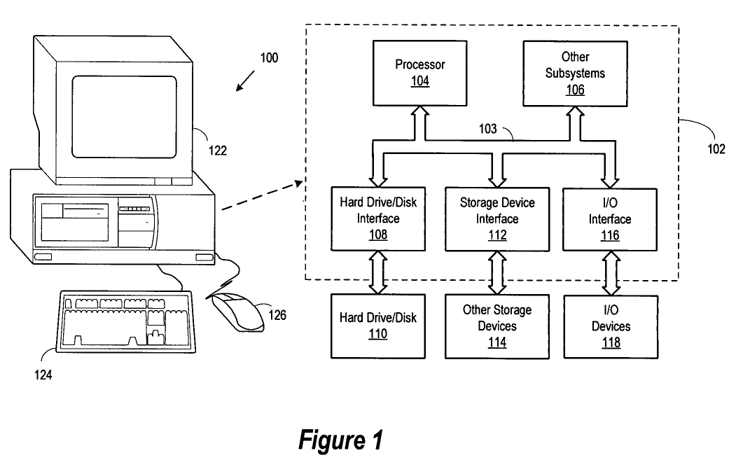

The method and apparatus of the present invention provides significant improvements in the manufacture and use of circuit boards such as those used in an information handling system 100 shown in FIG. 1. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring to FIG. 1, the information handling system 100 includes a main system board 102 that comprises a processor 104 and various other subsystems 106 understood by those skilled in the art. Data is transferred between the various system components via various data buses illustrated generally by bus 103. A hard drive 110 is controlled by a hard drive/disk interface 108 that is operably connected to the hard drive/disk 110. Likewise, data transfer between the system components and other storage devices 114 is controlled by storage device interface 112 that is operably connected to the various other storage devices 114, such as CD ROM drives, floppy drives, etc. An input/output (I/O) interface 116 controls the transfer of data between the various system components and a plurality of input/output (I/O) devices, such as a display 122, a keyboard 124, a mouse 126.

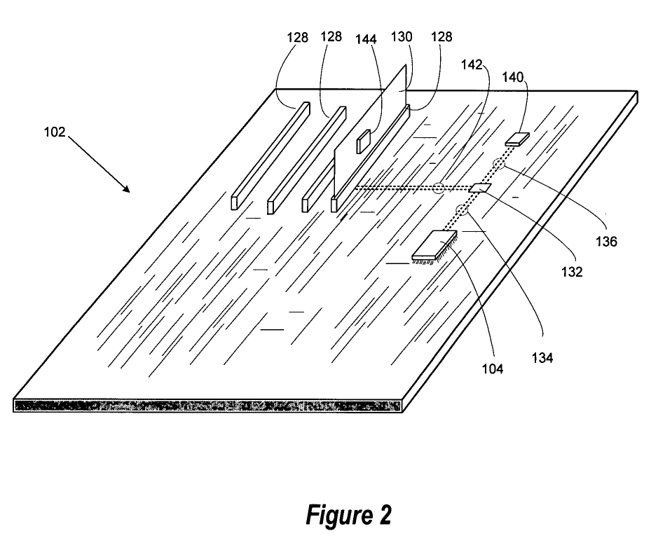

FIG. 2 is a generalized illustration of a printed circuit board such as the main system board (or motherboard) 102 discussed above in connection with FIG. 1. The circuit board 102 comprises a plurality of expansion card slots 128 that can connect expansion circuit boards, such as circuit board 130, to enhance the functionality of the information handling system 100. In an embodiment of the present invention, the expansion slots 128 communicate with the other system components over a bus that conforms to the PCI-Express protocol in accordance with the PCI-Express Base Specification Revision 1.0, published on Jul. 22, 2002 (the “PCI-Express Specification”).

For manufacturing efficiency, it is desirable to fabricate a main system board 102 circuit board with a plurality of conductors that can be connected (or left unconnected) to configure the circuit board for a particular application. A jumper can be used during the manufacturing process to connect a first conductor pair carrying data signals to a second conductor pair to route signals to various system components in accordance with a predetermined configuration. For example, a jumper or combination of jumpers, illustrated generally by reference numeral 132, can be used to connect the conductor pair 134 to conductor pair 136 to transmit signals to a specific destination, such as an on-board PCI-Express circuit 140. Alternatively, the jumper 132 can be used to connect the conductor pair 134 to conductor pair 142 to transmit signals to a PCI-Express circuit 144 on the expansion circuit board 130.

As was discussed hereinabove, PCI-E circuit boards are required to have AC coupling capacitors on the transmit signal conductors of the circuit board. In particular, the AC coupling capacitor requirements are described in Chapter 4 of the PCI Express Card Electromechanical Specification Revision 1.1, Mar. 28, 2002, which by this reference is incorporated for all purposes.

For PCI-E devices that transmit data high data rates over high speed differential signal (HSDS) conductor pairs, there is the additional need to provide a matched impedance solution for the configuration jumpers used to configure the main system circuit boards. The various embodiments of the configuration jumper of the present invention described below provide a solution to both of these design requirements. Specifically, some of the embodiments of the configuration jumpers described below can be used to provide the required capacitors for use with PCI-E devices—with differential signal conductors or with non-differential conductors. Other embodiments of the configuration jumper provide both the required PCI-E coupling capacitors and impedance matching for use with HSDS differential conductor pairs operating at high data transmission rates.

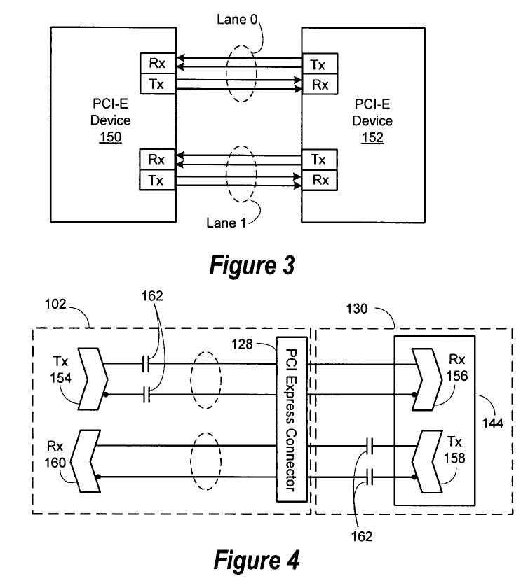

FIG. 3 is an illustration of a PCI-E topology wherein first and second PCI-E devices 150 and 154 transmit data over a plurality of differential conductors that define transmission “lanes.” As illustrated in FIG. 4, one of the PCI-E devices 144 can be on the expansion board 130 that is connected to the main system board 102 via the PCI-E connector 128. In the topology illustrated in FIG. 4, the respective signal transmission paths between the transmitters and receivers comprise a plurality of coupling capacitors. Typically, the coupling capacitors reside on the circuit board where the transmitter of the device is located. For example transmitter 154 transmits signals to receiver 156 over a transmission path that comprises coupling capacitors 162. Likewise, transmitter 158 transmits signals to receiver 160 over a transmission path comprising coupling capacitors 162. While the capacitors typically are located on the circuit board where the PCI-E devices located, it is possible to locate the coupling capacitors elsewhere, such as the configuration jumper of the present invention.

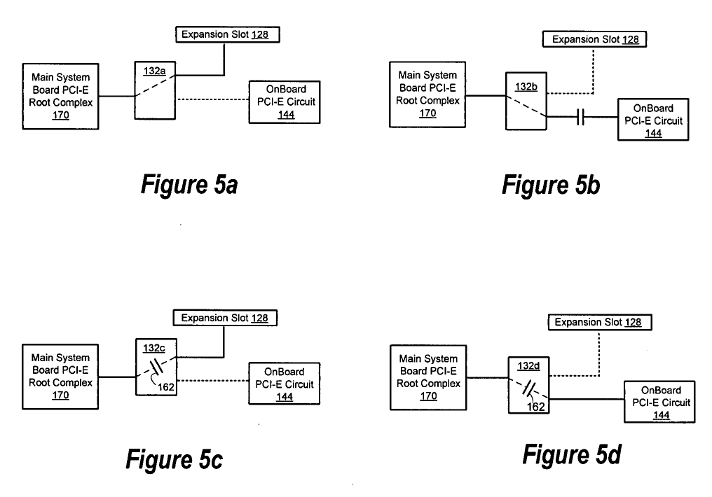

FIGS. 5a-d illustrate a plurality of capacitance-compensated configuration jumpers 132a-d that can be used to configure a main system board to selectively couple a PCI-E root complex 172 to an onboard PCI-E circuit 144 or to an expansion slot 128. For example, in the embodiment of the invention illustrated in FIG. 5a, the PCI-E root complex 170 is coupled by configuration jumper 132a to the expansion slot 128. In the embodiment illustrated in FIG. 5b, the PCI-E root complex 170 is operably coupled to the onboard PCI-E circuit 144. In the embodiments illustrated in FIGS. 5a and 5b, the configuration jumpers 132a and 132b do not comprise AC coupling capacitors. FIGS. 5c and 5d illustrate configuration wherein the configuration jumpers 132c and 132d comprise coupling capacitors 162 that provide capacitance matching in accordance with the PCI-Express standard. As used herein, “capacitance-compensated” refers to a predetermined capacitance or a jumper that is selected to optimize signal transmissions for a particular application, such as for the AC coupling requirements for PCI-Express.

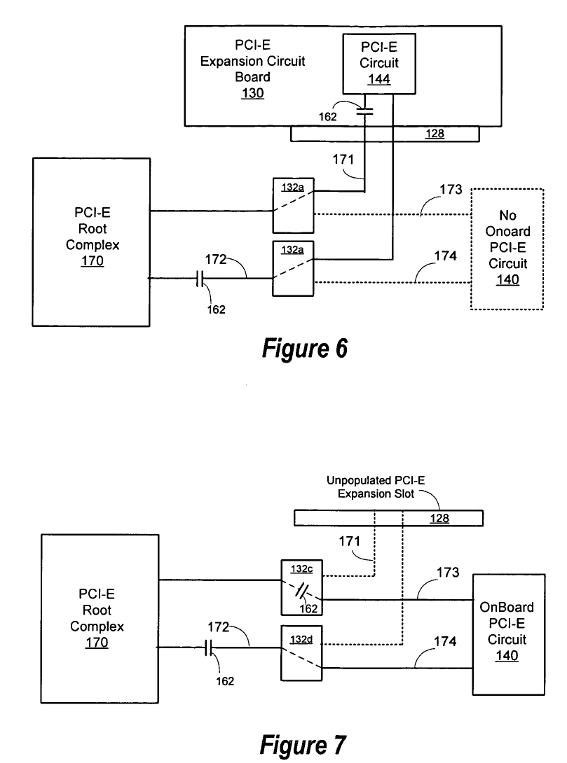

Additional details relating to the various embodiments of the configuration jumpers 132a-d can be seen by referring to FIGS. 6-9. In the embodiment illustrated in FIG. 6, an expansion circuit board 130 comprises a PCI-E circuit 144 that is operably connected to the PCI-E expansion connector 128. The transmit signal conductor 171 of the PCI-E circuit 144 comprises an AC coupling capacitor 162. Since the transmit signal conductor 171 comprises an AC coupling capacitor, the configuration jumper 132a does not comprise a coupling capacitor. The transmit signal conductor 172 from the PCI-E root complex 170 also comprises a coupling capacitor (on the main system board 102) and, therefore, this conductor is connected to the PCI-E circuit 144 by a jumper 132a that does not comprises a coupling capacitor.

In the embodiment of the invention illustrated in FIG. 7, the PCI-E root complex 170 is coupled to a PCI-E circuit 140 that is on the main system board 102. In this embodiment, the transmit conductor 173 of the PCI-E circuit 140 does not comprise an AC coupling capacitor. Therefore, the jumper 132c used to connect the conductor 173 to the PCI-E root complex comprises an AC coupling capacitor 163. The transmit conductor 172 from the PCI-E root complex 170 comprises a coupling capacitor 162 (on the main system board) and, therefore, a configuration jumper 132d without an AC configuration capacitor is used to connect the transmit conductor 172 to the onboard PCI-E circuit 140.

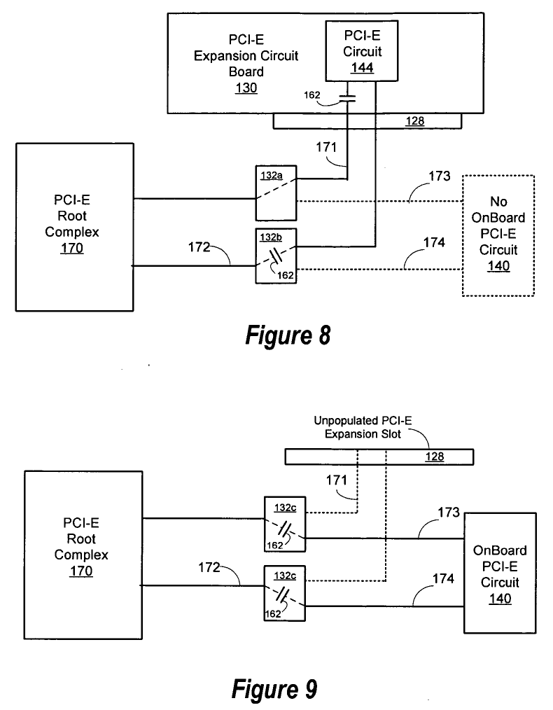

In the embodiment illustrated in FIG. 8, an expansion circuit board 130 comprises a PCI-E circuit 144 that is operably connected to the PCI-E expansion connector 128. The transmit signal conductor 171 of the PCI-E circuit 144 comprises a coupling capacitor 162. Since the transmit signal conductor 171 comprises an AC coupling capacitor, the configuration jumper 132a does not comprise a coupling capacitor. The transmit signal conductor 172 from the PCI-E root complex 170 does not comprise a coupling capacitor and, therefore, this conductor is connected to the PIC-E circuit 144 by a jumper 132b that comprises a coupling capacitor 162.

In the embodiment of the invention illustrated in FIG. 9, the PCI-E root complex 170 is coupled to a PCI-E circuit 140 that is on the circuit board 102. In this embodiment, the transmit conductor 173 of the PCI-E circuit 140 does not comprise an AC coupling capacitor. Therefore, the jumper 132c used to connect the conductor 173 to the PCI-E root complex comprises an AC coupling capacitor 163. The transmit conductor 172 from the PCI-E root complex also does not comprise an AC coupling capacitor. Therefore another configuration jumper 132c with an AC coupling capacitor 162 is used to couple the transmit conductor 172 to the onboard PCI-E circuit 140.

Although not explicitly shown in FIGS. 5a-5d, and FIGS. 6-9, the various conductors used to connect the PCI-E root complex 170 to the PCI-E circuit 144 on the expansions board 130 or to the on-board PCI-E circuit 140 are differential signal pairs. Furthermore, it should be understood that differential signal pairs comprising a capacitor 162 will have a capacitor on each of the individual conductors in the differential signal pair.

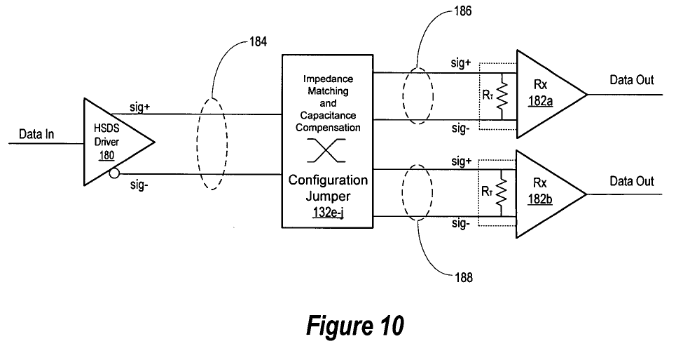

FIG. 10 is an illustration of an embodiment configuration jumper 132e-j of the present invention wherein the configuration jumper comprises the AC coupling capacitors required for PCI-E devices and also provides matched-impedance to minimize problems associated with high data rate transmissions in a point-to-point high speed differential signaling (HSDS) configuration. In the embodiment illustrated in FIG. 10, an HSDS driver 180 transmits data to one of two possible receivers 182a or 182b. The capacitance-compensated, impedance-controlled jumper 132e-j is operable to connect the differential conductor pair 184 with the differential conductor pair 186 or the differential conductor pair 188 depending on the configuration of the information handling system.

As will be understood by those of skill in the art, the differential signaling protocol provides for a positive signal to be placed on one conductor and a negative signal to be placed on the other conductor of the differential conductor pair. In most configurations for point-to-point data transmission, the characteristic impedance Z₀ of the differential conductor pair is 100 ohms. The HSDS configuration shown in FIG. 10 is an illustrative example of a data transmission system wherein embodiments of the capacitance-compensated, matched-impedance jumper of the present invention can be used to improved data transmission. While this specific example has been illustrated for discussion purposes, the present invention can be used to improve data transmission in any system employing differential signaling techniques.

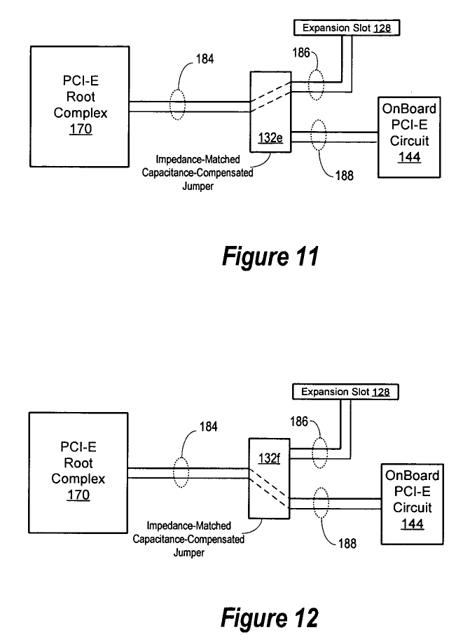

Specific embodiments for the matched-impedance jumper 132e-j of the present invention are illustrated in more detail below in FIGS. 11-18. As will be understood by those of skill in the art, matched-impedance refers to the condition in which the impedance of a component or circuit is equal to the internal impedance of the source, or the surge impedance of a transmission line, thereby giving maximum transfer of energy from source to load, minimum reflection, and minimum distortion. The signal loss associated with the reflection of signals resulting from an impedance mismatch is determined by the reflection coefficient, Γ, that can be calculated using following formula:

$$Γ = \frac{{v}_{r}}{{v}_{i}} = \frac{{z}_{t} - {z}_{0}}{{z}_{t} + {z}_{0}} ;$$

where:

vᵣ=reflected voltage

Vᵢ=incident voltage

zₜ=termination impedance

zₒ=characteristic impedance

Other factors relating to impedance matching include: 1) the size and shape of the signal conductors, 2) the material used to make the conductors, 3) the spacing between the conductors, 4) the size and type of ground associated with the conductors, 5) the distance between the conductors and the ground, and 6) the effective dielectric constants of the operating environment (e.g., air) and materials used to manufacture the circuit board and substrate materials used in the jumper. In accordance with the present invention, each of the aforementioned factors is optimized to provide an impedance-matched jumper to provide optimum signal transmission.

Referring to FIG. 11, a PCI-E root complex 170 with differential signaling capability is connected to an impedance-matched jumper 132e that comprises capacitance compensation and internal impedance-matched conductors to transmit the signals to a differential conductor pair 186 connected to an expansion slot 128 as illustrated above in FIG. 2. In the embodiment illustrated in FIG. 12, the PCI-E root complex 170 is connected by a capacitance-compensated, impedance-matched jumper 132f to differential conductor pair 188 that is coupled to an onboard PCI-E circuit 140 as illustrated in FIG. 2. In the various embodiments of the present invention, the capacitance-compensated, impedance-matched jumper 132e-j is a passive connector having improved signal transmission characteristics to facilitate high data transmission rates. The internal capacitance-compensated, impedance-matched conductors of jumpers 132e-j, therefore, do not comprise any active components, such as FETs, and are fixed in one of the two configurations illustrated in FIGS. 11 and 12. While the impedance-matched jumpers 132e-j shown in FIGS. 11 and 12 are described as being adapted to connect the first differential pair 184 to one of two possible secondary differential pairs 186 or 188, the present invention can be adapted to connect the first differential pair 184 to a secondary differential pair selected from a plurality (i.e., two or more) possible secondary differential pairs.

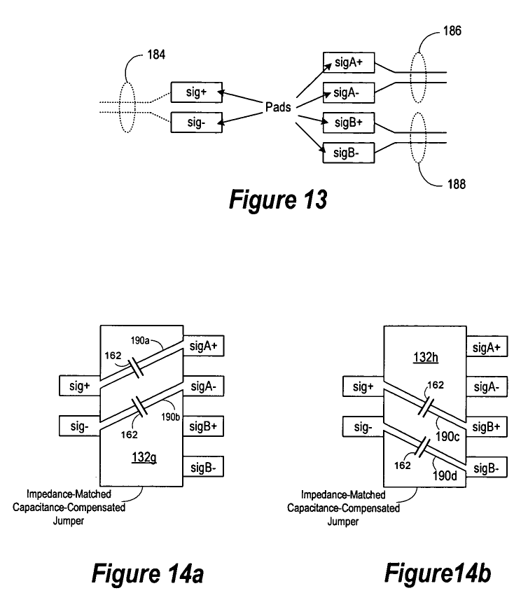

FIG. 13 is an illustration of connection pads for the various conductor pairs illustrated in FIGS. 11 and 12. As can be seen in FIG. 13, differential conductor pair 184 is connected to a “signal +” and a “signal −” pad. The receiver differential conductor pair 186 is connected to a “signal A+” and a “signal A−” pair of conductor pads. Likewise, receiver conductor pair 188 is connected to “signal B+” and “signal B−” conductor pads.

The embodiments of the impedance-matched jumpers 132g and 132h shown in FIGS. 14a and 14b, respectively, have connectors that are designed to attach to the corresponding pads shown in FIG. 13 to provide a capacitance-compensated, matched-impedance connection. Each of the embodiments of the capacitance-compensated, impedance-matched jumper provides internal conductors to transmit signals between the respective connector pads with minimal signal degradation. In particular, as discussed in greater detail below, the pad spacing and the conductor placement within the impedance-matched jumper provides a matched-impedance pass-through connector. Referring to FIG. 14a, the capacitance-compensated, impedance-matched jumper 132g comprises first and second internal conductors 190a and 190b that connect transmit connection pads “Sig +” and Sig −” to receive connection pads “Sig A+” and “Sig A−.” The impedance-matched jumper 132h shown in FIG. 14b comprises first and second internal conductors 190c and 190d that connect transmit connection pads “Sig +” and Sig −” to receive connection pads “Sig B+” and “Sig B−.”

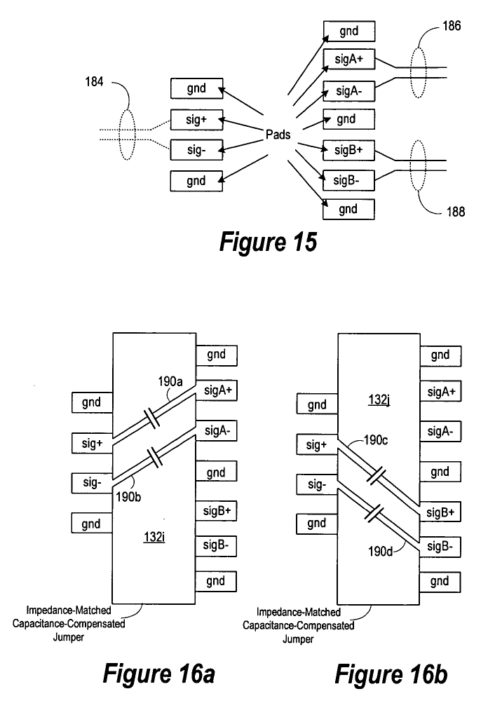

FIGS. 15 and 16a,b illustrate an embodiment of the invention that provides enhanced bandwidth by adding a plurality of ground connection pads at predetermined locations with respect to the differential signal conductor pairs. As can be seen in FIG. 15, each of the connection pads for the transmit and receive differential conductor pairs are adjacent to a ground pad. The capacitance-compensated, impedance-matched jumpers 132i and 132j shown in FIGS. 16a and 16b, respectively, have connectors that are designed to attach to the corresponding differential signal pads and ground pads shown in FIG. 15 to provide an enhanced matched-impedance connection. Using the embodiment of the invention shown in FIGS. 15 and 16a,b it is possible to control impedance more than +/−15% of the requirements for current 3 Gbps signal transmission standards and higher signal transmission speeds in the future.

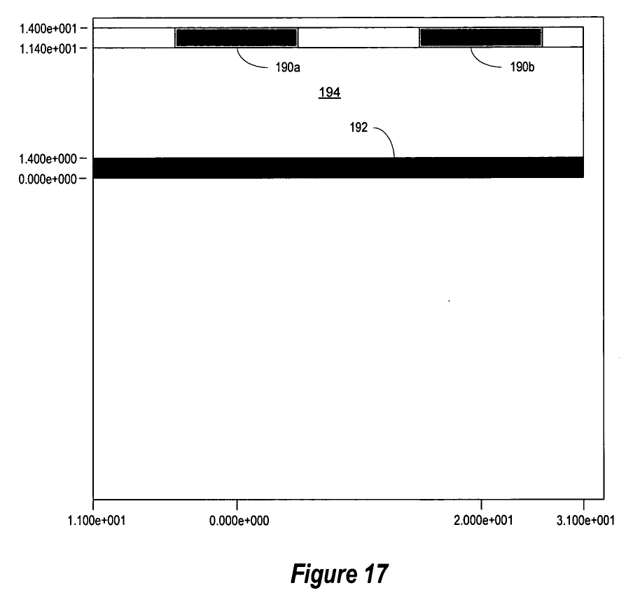

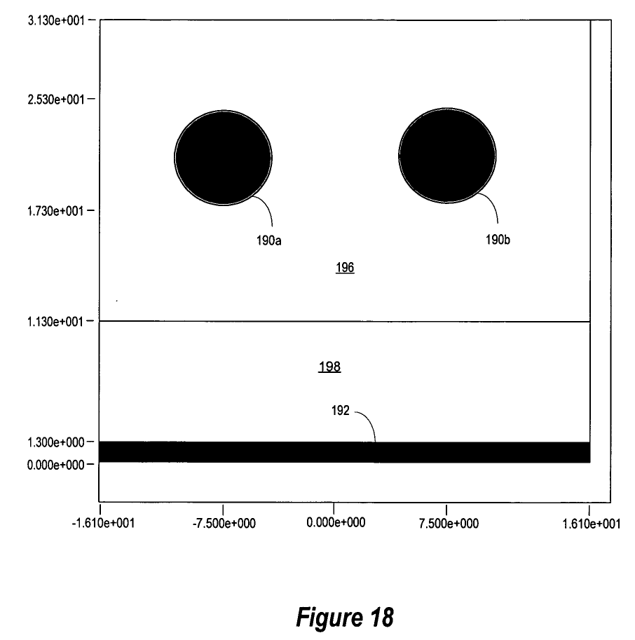

FIG. 17 shows example geometries for conductor pads 190a and 190b to create 100 ohms differential impedance in the various embodiments of the impedance controlled jumper of the present invention. The embodiment shown in FIG. 17 comprises 10-mil pads 190a and 190b on a 20-mil pitch spaced 10 mils above a ground 192. Above a 10-mil dielectric 194, the pads illustrated in FIG. 17 will create an impedance of 100 ohms. FIG. 18 shows example geometries of 8 mil conductors 190a and 190b embedded in a plastic substrate 196 and spaced 6 mils above a 10 mil dielectric 198 and a total of 16 mils above a ground 192. The examples of connector pads and internal conductors discussed above are representative examples of geometries that can provide improved differential signal performance in accordance with the present invention, but other geometries can be implemented in the scope of the present invention.

While the various embodiments of the invention as discussed hereinabove have been described in connection with differential signaling conductors, the advantages of the present invention can also be applied to other configurations, including single-ended conductors. Although the present invention has been described in detail, it should be understood that various changes, substitutions and alterations can be made hereto without departing from the spirit and scope of the invention as defined by the appended claims.

What is claimed is:

1. A capacitance-compensating jumper for connecting a first signal conductor to a predetermined second signal conductor selected from a plurality of second signal conductors, comprising:
a first jumper connector operable to couple an electrical signal to said first signal conductor;
a second jumper connector operable to couple an electrical signal to said predetermined second signal conductor; and
an internal conductor defining a signal path between said first and second jumper connectors;
wherein said internal conductor has a predetermined capacitance to provide a compensating AC coupling capacitance for the signal path defined by said first conductor, said predetermined second conductor and said internal conductor.

2. The jumper according to claim 1, wherein said first signal conductor comprises an AC coupling capacitor and said internal conductor does not comprise an AC coupling capacitor.

3. The jumper according to claim 1, wherein said predetermined second signal conductor comprises an AC coupling capacitor and said internal conductor does not comprise an AC coupling capacitor.

4. The jumper according to claim 1, wherein said internal conductor comprises an AC coupling capacitor.

5. The jumper according to claim 1, wherein the combined capacitance of said first conductor, said second conductor and said internal conductor of said jumper is between 75 and 200 nF.

6. A method of transmitting signals in a circuit, comprising:
connecting a first terminal of a configuration jumper to a first conductor;
connecting a second terminal of said configuration jumper to a predetermined second conductor selected from a plurality of second conductors;
transmitting a signal over the signal path defined by said first conductor, said predetermined second conductor and said configuration jumper;
wherein said configuration jumper comprises a capacitance to create a predetermined AC coupling capacitance in said signal path when combined with the capacitance of said first conductor and said second conductor.

7. The method according to claim 5, wherein said first signal conductor comprises an AC coupling capacitor and said configuration jumper does not comprise an AC coupling capacitor.

8. The method according to claim 5, wherein said predetermined second signal conductor comprises an AC coupling capacitor and said configuration jumper does not comprise an AC coupling capacitor.

9. The method according to claim 5, wherein said configuration jumper comprises an AC coupling capacitor.

10. The method according to claim 5, wherein the combined capacitance of said first conductor, said second conductor and said internal conductor of said jumper is between 75 and 200 nF.

11. A circuit board, comprising:
a first conductor;
a plurality of second conductors; and
a capacitance compensating configuration jumper comprising a jumper conductor operably connecting said first conductor to a predetermined second conductor from said plurality of second conductors;
wherein said jumper conductor has a predetermined capacitance to provide a compensating AC coupling capacitance for the signal path defined by said first conductor, said predetermined second conductor and said jumper conductor.

12. The circuit board according to claim 11, wherein said first signal conductor comprises an AC coupling capacitor and said internal conductor does not comprise an AC coupling capacitor.

13. The circuit board according to claim 11, wherein said predetermined second signal conductor comprises an AC coupling capacitor and said internal conductor does not comprise an AC coupling capacitor.

14. The circuit board according to claim 11, wherein said internal conductor comprises an AC coupling capacitor.

15. The circuit board according to claim 11, wherein the combined capacitance of said first conductor, said second conductor and said internal conductor of said jumper is between 75 and 200 nF.

16. An information handling system, comprising:
at least one circuit board comprising information processing circuits and signal conductors, said circuit board further comprising:
a first conductor;
a plurality of second conductors; and
a capacitance compensating configuration jumper comprising a jumper conductor operably connecting said first conductor to a predetermined second conductor from said plurality of second conductors;
wherein said jumper conductor has a predetermined capacitance to provide a compensating AC coupling capacitance for the signal path defined by said first conductor, said predetermined second conductor and said jumper conductor.

17. The information handling system according to claim 16, wherein said first signal conductor comprises an AC coupling capacitor and said internal conductor does not comprise an AC coupling capacitor.

18. The information handling system according to claim 16, wherein said predetermined second signal conductor comprises an AC coupling capacitor and said internal conductor does not comprise an AC coupling capacitor.

19. The information handling system according to claim 16, wherein said internal conductor comprises an AC coupling capacitor.

20. The information handling system according to claim 16, wherein the combined capacitance of said first conductor, said second conductor and said internal conductor of said jumper is between 75 and 200 nF.
